(19) United States
(12) Patent Application Publication
(10) Pub. No.: US 2016/0117941 A1
(43) Pub. Date: Apr. 28, 2016

(54) SYSTEM AND METHOD FOR FACILITATING EMERGENT LEARNING IN RELATION TO KNOWLEDGE CONTENT

(71) Applicants: Gail Joyce MITCHELL, Midland (CA); Ronald Davis OWSTON, Newmarket (CA); Nadine Louise CROSS, Toronto (CA); Donald Walter SINCLAIR, Toronto (CA); Renate H. WICKENS, Kitchener (CA); Michaela HYNIE, Toronto (CA); Rufus Obadiah GEORGE, Toronto (CA); Srividhyavathi ABBAI, Scarborough (CA); Eldhose CYRIAC, Bangalore (IN); Waleed Anwar BUTT, Mississauga (CA); Kari Lynne KUMAR, Winnipeg (CA)

(72) Inventors: Gail Joyce MITCHELL, Midland (CA); Ronland Davis OWSTON, Newmarket (CA); Nadine Louise CROSS, Toronto (CA); Donald Walter SINCLAIR, Toronto (CA); Renate H. WICKENS, Kitchener (CA); Michaela HYNIE, Toronto (CA); Rufus Obadiah GEORGE, Toronto (CA); Srividhyavathi ABBAI, Scarborough (CA); Eldhose CYRIAC, Bangalore (IN); Waleed Anwar BUTT, Mississauga (CA); Kari Lynne KUMAR, Winnipeg (CA)

(21) Appl. No.: 14/889,934

(22) PCT Filed: May 9, 2014
(86) PCT No.: PCT/CA2014/000427

§ 371 Date: Nov. 9, 2015

Related U.S. Application Data
(60) Provisional application No. 61/821,400, filed on May 9, 2013.

(51) Int. Cl. G09B 5/12; G06Q 10/10

(52) U.S. Cl. CPC G09B 5/12; G06Q 10/101

(57) ABSTRACT

A content navigation/discovery system is provided. A computer is linked to a library of information objects, and includes a content navigation/discovery utility that includes both a global content discovery utility that is made available to a plurality of users to navigate/discover a plurality of information objects using one or more content filters presented in a content navigation/discovery interface, and a private or semi-private content discovery utility that is made available to one or more selected users for a selected group of users. The global content discovery utility and the private or semi-private content discovery tool are integrated so as to support user workflows that allow one or more users to selectively interact with content through the global content discovery utility and/or the primate or semi-private content discovery utility, and configured to promote emergent and collaborative learning. Related computer implemented methods are also provided. The computer system may be implemented as an e-learning platform or a part thereof.

### CROSS-REFERENCE TO RELATED APPLICATION AND CLAIM OF PRIORITY

The present application claims priority to U.S. provisional patent application No. 61/821,400 filed on May 9, 2013, the entire contents of which are hereby incorporated by reference.

### FIELD OF INVENTION

The present invention relates to online education. The present invention also relates to a content discovery tools.

### BACKGROUND OF THE INVENTION

Online education is growing quickly.

Learning Management Systems (LMS's) are also becoming common, for managing educational content, including for dissemination via the Internet.

Prior art systems and solutions for e-learning are generally linear and do not address modern pedagogical trends, including non-linear learning and collaboration.

There is a need for online educational platforms that are more engaging and meet learning objectives such as diversity and collaboration.

### SUMMARY OF THE INVENTION

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

In an aspect of the invention, a computer system is provided for navigating a plurality of information objects and discovering one or more of the information objects of interest comprising: (a) at least one computing device linked to a library of information objects, and providing access to a content navigation/discovery utility including: (i) a global content discovery utility that is made available to a plurality of users to navigate/discover a plurality of information objects using one or more content filters presented in a content navigation/discovery interface; and (ii) a private or semi-private content discovery utility that is made available to one or more selected users; wherein the global content discovery utility and the private or semi-private content discovery tool are integrated so as to support user workflows that allow the plurality of users to selectively interact with content through the global content discovery utility and/or the private or semi-private content discovery utility so as to promote emergent and collaborative learning.

In an embodiment the content navigation/discovery utility is configured to allow the plurality of users to navigate and access content in an intuitive way using multiple visual fields.

In an embodiment, the computer system comprises a content engagement utility that enables the plurality of users to interact with the plurality of information objects and interact with one another regarding the plurality of information objects, such interactions including one or more of: (a) teacher-student interactions, (b) student-student interactions, (c) group-group interactions, (d) class-class interactions, (e) course-course interactions, (f) discipline-discipline interactions, (g) leader-follower interactions, (h) supervisor-worker interactions, or (i) researcher-team interactions.

In some embodiments, the content navigation/discovery utility is configured to allow the plurality of users to share in each other's learning.

In some embodiments, the content navigation/discovery utility is the navigation/discovery utility enables the plurality of users to annotate the plurality of information objects

In some embodiments, the navigation/discovery utility enables the plurality of users to annotate at least one of the plurality of information object with one or more perspective

In some embodiments, the one or more content filters enable users to filter and view the plurality of information objects based on one or more of content perspectives, keywords, contributor attributes, courses associated with the plurality of information objects, or date associated with the plurality of information objects.

In an embodiment, the computer system further comprises a utility for encoding the plurality of information objects with emotional responses of the plurality of users to the plurality of information objects based on one or more of understanding, inquiry or changes in thinking.

In another embodiment, the computer system further comprises a journal writing tool that enables the plurality of users to reflect on learning or response to the plurality of information objects.

In some embodiments, the entries to the journal writing tool are used to automatically encode the plurality of information objects for guiding the plurality of users in navigation/discovery of the plurality of information objects.

In an embodiment, the computer system is configured to enable the one or more selected users to transfer the plurality of information objects between the global content discovery utility and the private or semi-private content discovery utility.

In some embodiments, the content navigation/discovery utility is configured to: (a) display an array of graphical objects representing one or more of the plurality of information objects, the graphical objects including one or more visual attributes that are associated with or indicative of one or more content attributes for the corresponding plurality of information objects, and wherein the visual attributes are linked to the one or more content filters, thereby permitting at least one of the plurality of users to navigate/discover content by selecting, including iteratively, one or more filter options, and thereby triggering changes to the array, wherein the array or changes to the array reveal content related patterns across the plurality of information objects.

In some embodiments, the one or more content attributes comprises a user response of at least one of the plurality of users relevant to at least one of the plurality of information objects.

In an embodiment, the content/navigation discovery tool is configured for: (a) recognition of one or more user responses relevant to at least one of the plurality of information objects; and (b) embedding the one or more user responses into the at least one of the plurality of information objects.

In some embodiments, the system receives user responses from: (a) one or more graphical user interfaces; and (b) one or more input processors.

In some embodiments, the one or more graphical user interfaces comprises a means for the plurality of users to input the one or more user responses.

In some embodiments, the one or more input processors comprises a camera.

In an aspect of the invention, there is a computer implemented method for engaging in emergent learning comprising: (a) using one or more processors, initiating one or more content navigation/discovery routines of a navigation/discovery computer networking resource; (b) one or more users accessing one or more information objects from a library, and the one or more users selectively interacting with the one or more information objects from either (i) a global content discovery utility that is made available to the one or more users to navigate/discover the one or more information objects using one or more content filters presented in a content navigation/discovery interface; or (ii) a private or semi-private content discovery utility that is made available to one or more selected users, so as to enable emergent or collaborative learning;

In an embodiment, the method further comprises the one or more users navigating or accessing the one or more information objects in an intuitive manner using multiple visual fields presented by the navigation/discovery computer networking resource.

In some embodiments, the method further comprises the step of the one or more users interacting with the one or more information objects or one another regarding the one or more information objects, such interactions including one or more of: (a) teacher-student interactions, (b) student-student interactions, (c) group-group interactions, (d) class-class interactions, (e) course-course interactions, (f) discipline-discipline interactions, (g) leader-follower interactions, (h) supervisor-worker interactions, or (i) researcher-team interactions.

In some embodiments, the method further comprises enabling the one more users, based on such interactions, to share in each other's learning.

In an embodiment, the method further comprises: (a) the one or more users annotating the one or more information objects with one or more content perspectives, keywords, contributor attributes, courses associated with the one or more information objects, or date associated with the one or more information objects; (b) filtering the one or more information objects based on one or more of content perspectives, keywords, contributor attributes, courses associated with the one or more information objects, or dates associated with the one or more information objects

In an embodiment, the method further comprises the one or more users encoding the or more information objects with emotional responses of users to the one or more information objects based on one or more of understanding, inquiry or changes in thinking.

In another embodiment, the method further comprises the steps of the one or more users using a journal writing tool to encode the one or more information objects with reflections that enables the one or more users to reflect on learning or response to the one or more information objects.

In an embodiment, the method further comprises the one or more users: (a) viewing a series of icons representing the one or more information objects, and selectively accessing additional information regarding the one or more information objects; (b) selecting one or more perspective for at least one of the one or more information objects, thereby triggering a change in one or more visual attributes of an associated icon; and (c) discovering one or more content relationships between the one or more information objects, using visual patterns between the icons.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a system diagram of the computer platform of the present invention, in one implementation thereof, and

FIG. 2 is a diagram illustrating the student and instructor related workflow with the system implemented by the present invention.

FIG. 3 is a diagram illustrating the student related workflow implemented by the present invention.

FIG. 4 is a diagram illustrating the teacher related workflow implemented by the present invention.

FIG. 5 illustrates a possible implementation of user hierarchies using the administrative utility of the computer platform of the present invention.

FIG. 6 illustrates a representative graphical user interface for an administrator, in this implementation an instructor, enabling the instructor to administer discussions created by users destined for the global network or GT.

FIG. 7 shows a representative view of an example graphical user interface to enable a user to encode emotional input or response using tags and/or a plurality of emoticons that can be selected by a user and associated with a resource or portion of a resource using an input means.

FIGS. 8A and 8B show representative views of an example graphical user interface for accessing the functions of the general collaborative content discovery tool (“GT”) of the present invention. FIG. 8A shows the GT wherein access is provided to a user enrolled in a course to all discussions in that specific course, with discussions displayed as a heat map and where larger tiles indicate level of participation. FIG. 8B shows the GT in respect of a global network wherein all public discussion is displayed in the heat map format, and where users can filter and sort discussions by various criteria as well as search discussions using keywords.

FIG. 9 illustrates a representative graphical user interface for accessing the functions of the specific collaborative content discovery tool (“ST”) of the present invention wherein all discussions a user has created or tagged to follow is displayed as a heat map.

FIG. 10 illustrates a representative graphical user interface for a user starting new discussions destined for a particular course or courses or for the global network, wherein the user may associate an image with the discussion, link the discussion to perspectives, attach resources or save the discussion draft for later. Discussions may be created in any course to which the user has been provided the invitation code, if so desired by the administrator.

FIG. 11 illustrates a representative graphical user interface of a landing page for a user upon logging into the application that provides access to aspects of the application and, for example, includes access to last accessed discussions.

FIG. 12 illustrates a representative graphical user interface of an instructor's course information page enabling the course instructor to create course descriptions and perspectives.

FIG. 13 illustrates a possible generic computer system implementation of the present invention;

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

### Definitions

This disclosure refers to “teachers”, who may be teachers, teaching assistants, professors, instructors, coaches (for example personal coaches or corporate coaches), mentors, tutors, or their designates involved in supporting learning activities, who may or may not be employed or otherwise engaged by educational institutions, businesses or government entities; “teachers” or their employers may also be referred to as “platform clients”.

“Learners” are any entities receiving educational content and/or creating new knowledge and/or participating in personal or collective learning activities or other forms of engagement through the platform (10). “Learners” may also be referred to as “students”.

This disclosure may refer to “teachers” as they are an important user group, and also their use of the platform illustrates the advantages of the computer system of the present invention, the application of the platform is not limited to teachers but can also apply to publishers, individuals, enthusiasts, or any other individual who may interested in transferring learning to another person. For this reason some of the references to “teachers” should also be understood to extend to “publishers”.

“Users” generally refers to authorized users of the platform, which may include “learners” or “students” and/or “teachers” as the context may require.

“Complexity science”: a complexity science perspective focuses on the relational qualities of organizations of all types and scales—complex organizational bodies like neuronal assemblies, biological bodies, social collectives, bodies of knowledge, governance structures and local ecologies. Complexity science is concerned not so much with attempting to isolate the parts of an organizational system as with understanding the relationships that give rise to the organizational whole.

Learning or teaching methods based on complexity science may be referred to as “complexity learning” or “complexity teaching” respectively.

“Recursion” or a “recursive curriculum” emphasizes the notion of returning—to look at educational content, yet again, in a new light, for the first time. Recursion is the end of non-linear, loop-like event that becomes the beginning of the next event which is contextually rich and relational.

“Relations” as in a “curriculum of relations” refers to a curriculum filled with connections and interconnections, and it calls for adding continuously to these connections, making the overall system deeper and richer.

“Richness” as it relates to curriculum refers to a curriculum that is based on openness, (also referred to as generativity), multiple layers of interpretation, and varied realms of meaning. A rich curriculum is one that is replete with problems, perturbations and possibilities.

“Rigor” refers not so much to strict conformity to a preset procedure as to the careful exploration of multiple possibilities and unstated assumptions.

“Emergent learning” is the learning that occurs as a new pattern through non-linear creative, deliberate play, interaction, exploration and reflection. Conditions for emergence are conversations, stories, problems, unsolved situation, and incomplete understandings.

“Aha moments” or “insights” refer to moments of clarity, defining insights of learning where one can gain wisdom or understand a new pattern.

“Teaching presence” is the design, facilitation, and direction of cognitive and social processes for the purpose of realizing personally meaningful and educationally worthwhile learning outcomes.

“Social presence” is the ability of learners to identify with the community, communicate purposefully, and develop inter-personal relationships by way of projecting their individual personalities.

“Cognitive presence” is the extent to which learners are able to construct and confirm meaning through sustained communication, reflection and discourse.

“Learning presence” represents elements such as self-efficacy as well as other cognitive, behavioral, and motivational constructs supportive of online learner self-regulation.

“Information objects” refers to any one individual or collection or materials, content, discussions, artefacts, whether visual or audio in nature, available in the content management platform to users, and may, for example purposes only, be articles, audio recordings, video, and including links to any content outside the platform.

“User responses” are any emotional, physical or other attribute of a user or users that, for example and not intended to be limiting, may indicate or signal the user's reactions, responses, or feelings relevant to the materials, contents or discussions available in the content management platform.

“Sensors” or “sensor devices” refer to any device capable of receiving user responses, and may be, for example and not to be limiting, a camera.

“Content attributes” refers to any characteristic or property of an information object whether inherent or intrinsic to said object, or attributed to related to said object by a user or the system.

“Visual attributes” refers to a visual or auditory signal, indicator or, without being limiting, other method of conveying information relevant to, associated with or indicative of content attributes of an information object.

### Online Learning Environment

In one aspect of the invention, a computer system is provided that provides a novel and innovative online learning environment. Additionally, a computer system is provided that enables the integration into an e-learning system of complexity thinking principles, as applied to pedagogy. In another aspect, a computer system and computer implemented method is provided that facilitates on-line learning in a manner that meets the requirements of “complexity teaching” or “complexity learning”.

Complexity teaching requires an active, learner-centred approach where students and teachers influence each other's emerging understanding. Complexity teaching promotes the use of concept-based, emergent and participatory educational content, that enables various participants to share in each other's learning. Another aspect of complexity teaching is an increased focus on student-centred learning.

In one aspect of the invention, an e-learning platform and e-learning computer system implemented method is provided that for the first time enables teachers and students to participate in an e-learning environment that is based on complexity teaching. More specifically the present invention allows students to collaborate with other students and also with teachers, and optionally for teachers to collaborate with other teachers and also with students, in regards to emergent learning, in a way that they can influence the learning of others.

In another aspect, the present invention includes particular tools that are designed to enable users to engage in participatory, emergent learning in an effective and engaging way. The inventors have designed system in a way that allows users to engage in complexity based learning in a way that is simple and easy to use, and that can be used on a range of different network-connected devices, while meeting the learning objectives discussed herein.

### Computer Network Platform

In one aspect of the invention, the platform (10) includes an online learning platform. The platform (10) may be integrated with a learning management system (“LMS”) (11) or may be a standalone system.

A skilled reader will understand that the present disclosure refers to use of the technology described in connection with e-learning, however, many other applications are possible. The present technology provides a mechanism for multiple users to interact with content of any type in a collaborative way, and in a way that promotes emergent learning as further explained below. The application of the technology to e-learning should be understood as being an example of the use of the present invention.

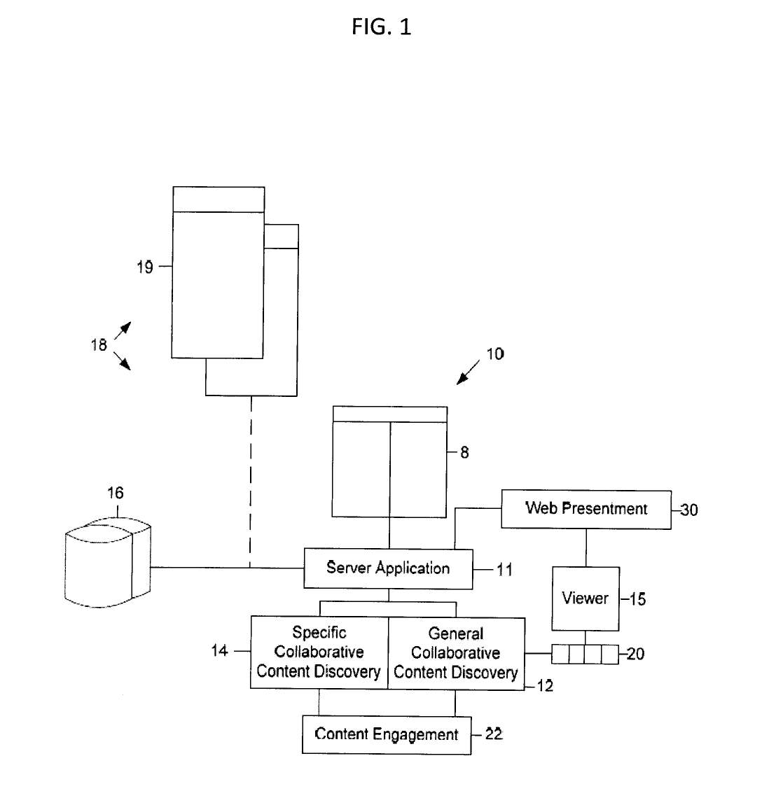

In one aspect of the invention, as illustrated in FIG. 1, the platform includes a general collaborative content discovery tool (GT) (12), and a specific collaborative content discovery tool (ST) (14). Both allow users to navigate and access content in an intuitive way using multiple visual fields.

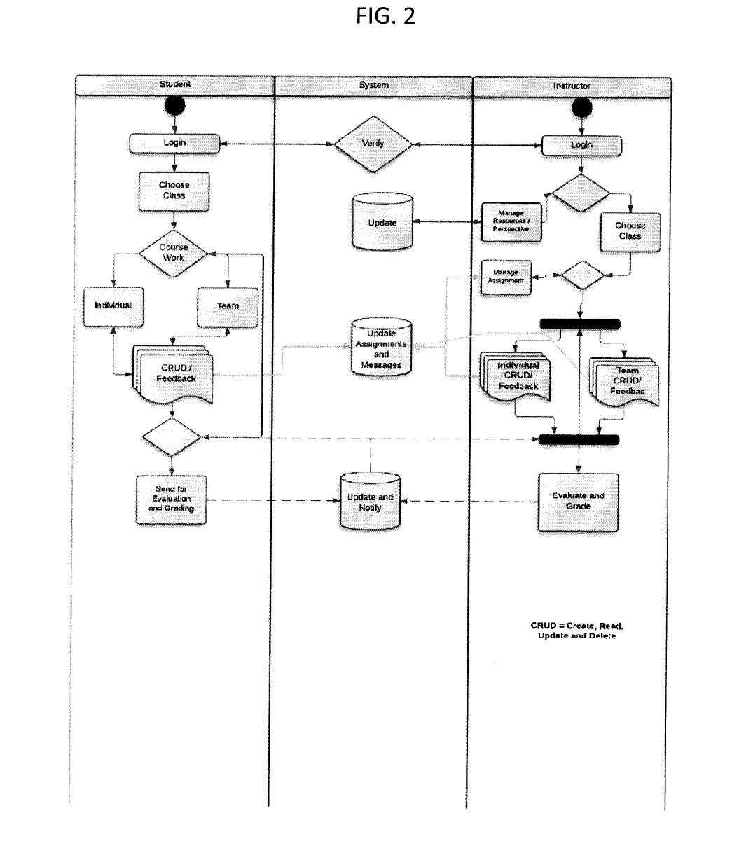

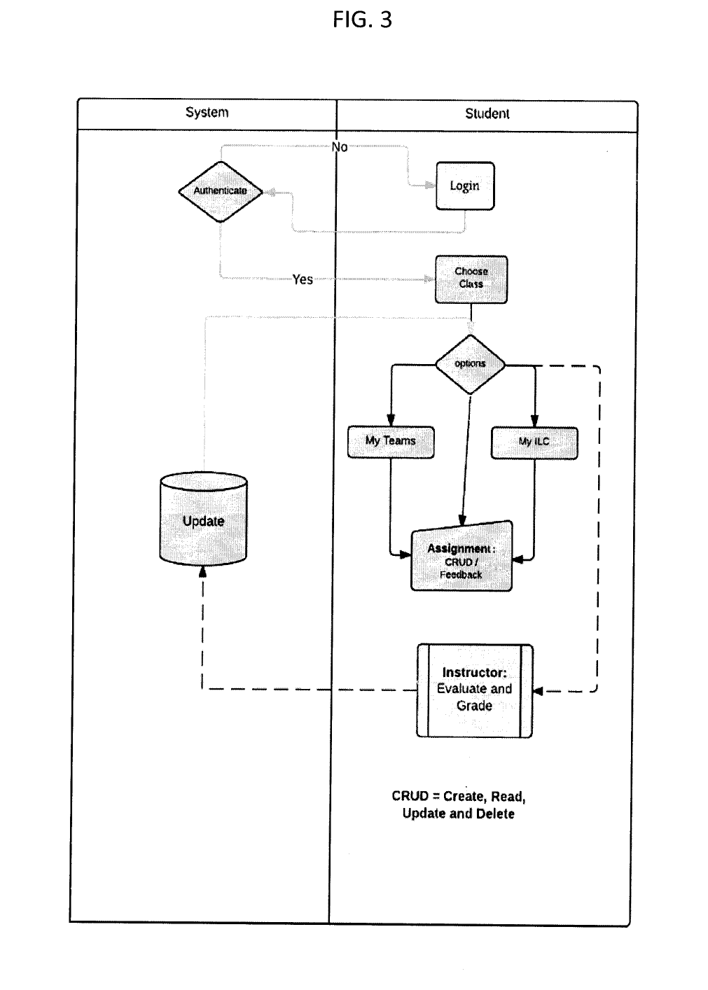

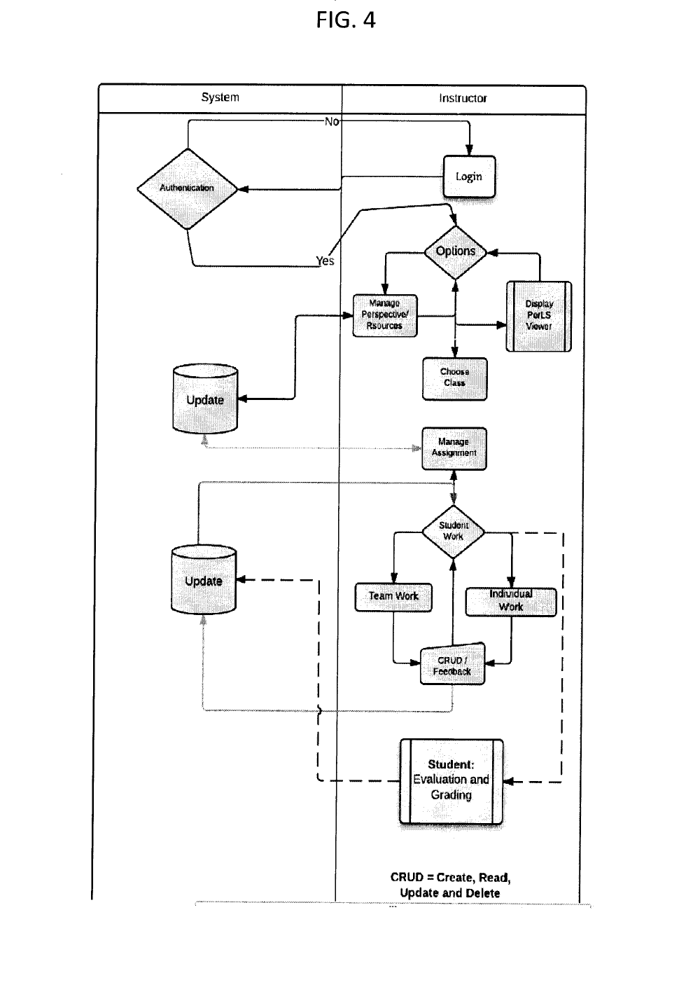

FIGS. 2 through 4 illustrate the various workflows between users and the system of the platform (10), for example the student and instructor related workflow implemented by the system (FIG. 2), a view of the student related workflow (FIG. 3) and the teacher related workflow implemented by the present invention (FIG. 4).

GT (12) may be understood as a viewer (15) that may be linked to one or more libraries or repositories (16). The repositories (16) may include for example text, images, web links, videos or other content, that may be populated by teachers and/or students. This content may be referred to collectively as “resources” in this disclosure (18). The GT (12) may be implemented as the “public” resources of the platform (10), as opposed to the ST (14), which will generally be less public and more private. However, it should be understood that users may be assigned varying levels of access within the ST (14).

Significantly, in the present invention, each resource (18) is associated with one or more perspectives (20). A perspective refers to a view point, concept, or big idea that is apparent in the course material and/or is determined by the teacher.

GT (12) may be configured in a number of ways so as to present multiple visual fields that are designed to enable the exploration of a significant number of resources in a way that presents to a user a significant number of options for viewing attributes of the resources in a visual manner so that the viewer is changeable by the user and permits the user to discover resources or associations between resources in a way that can be personally meaningful to the user.

The GT (12) may be implemented as a content publishing tool that allows content to be uploaded by all users of the platform (10). GT (12) includes or links to a plurality of content filtering tools that permit users for example to filter and view resources in multiple ways based on content perspectives, keywords, contributor identity, course, date, etc. GT (12) may enable students for example to see content linked with key words that has been contributed by all teachers-learners across disciplinary lines. For example, learners from one discipline (health) can examine content linked with poverty and death in health and also see content linked with poverty and death from a fine arts perspective or an economics perspective. This access to multiple visual fields, according to learner interest, enhances trans-disciplinary learning and exchange and inquiry.

ST (14) may be implemented as an online area or virtual space where students collect, reflect upon, and present their learnings. In one implementation, ST (14) may be implemented as a “learning cart”. ST(14) may include a series of functions and features of the platform (10) for enabling students to collect, reflect upon, and present their learnings.

For example, the ST (14) allows students to annotate content for example by using a digital “sticky note” to user selected resources.

The ST (14) may provide access to a journal writing tool or area that allows students to reflect, more intensively, in writing on the resources and/or other learning/responses to critical questions posed.

ST (14) may include or link to a content engagement utility or platform (22) that allows students to engage with content in a variety of ways, and that may include or link to various communication and messaging tools. In one implementation, the content engagement platform (22) supports multilevel discussions, and synchronous/asynchronous/instant messaging to open and sharing of resource/ideas/learnings. Significantly, the content engagement platform (22) may be configured so as to support, or be flexible enough to support, a variety of different interactions including across various learning related hierarchies. For example, the multilevel discussion regarding content facilitated by the content engagement platform (22) may include teacher-student interactions, student-student interactions, group-group interactions, class-class interactions, course-course interactions, discipline-discipline interactions, leader-follower interactions, supervisor-worker interactions, and researcher-team interactions.

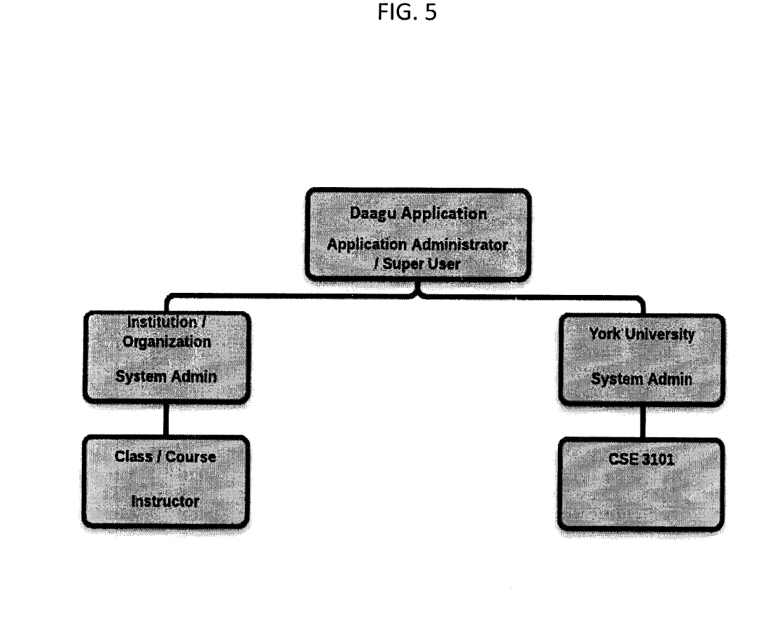

FIG. 5 illustrates a possible implementation of user hierarchies using the administrative utility of the computer platform of the present invention.

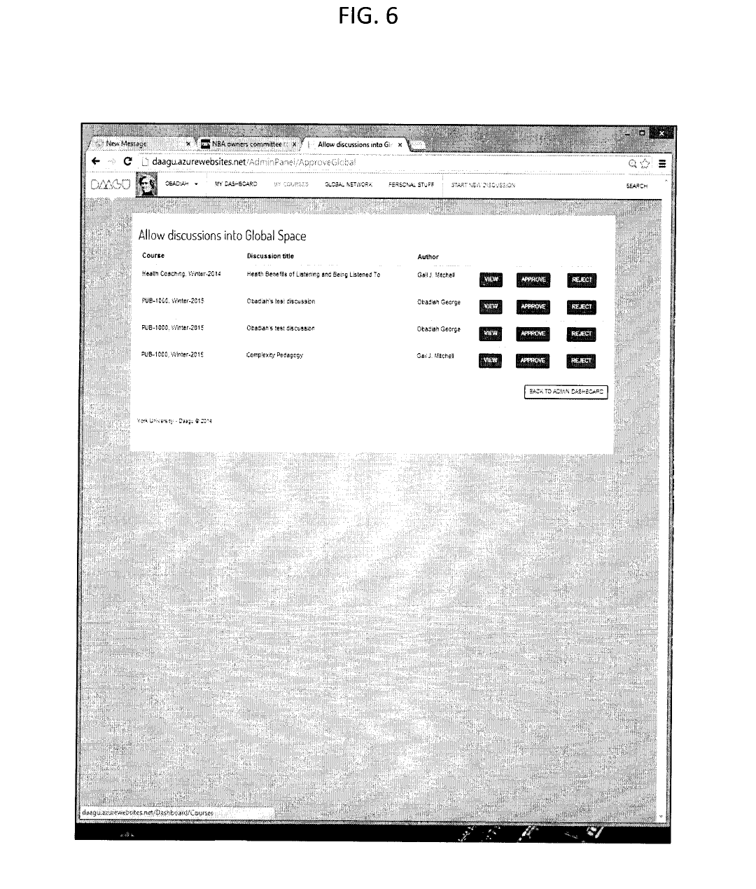

FIG. 6 illustrates a representative graphical user interface for an administrator, in this implementation an instructor, enabling the instructor to administer discussions created by users destined for the global network or GT to curate, modify or otherwise ensure content retains relevancy.

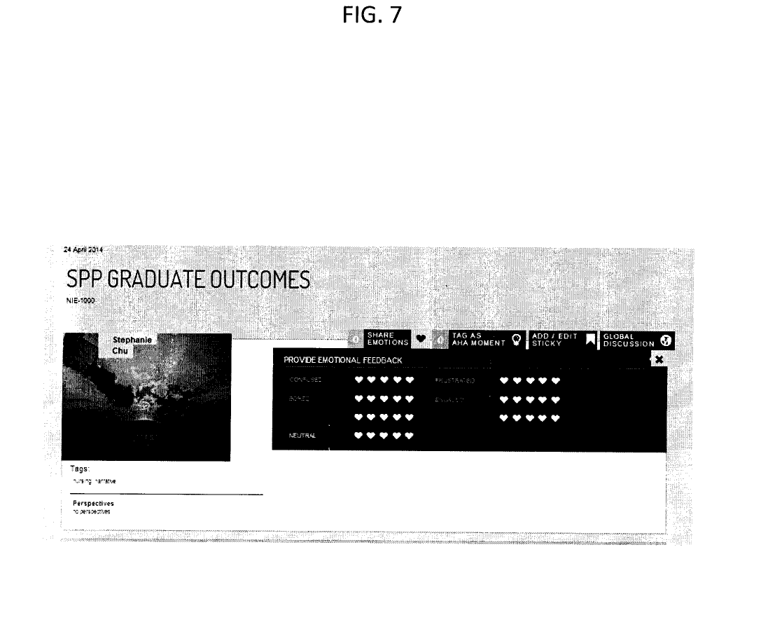

In another aspect of the invention, the content engagement platform (22) may be used to encode content in other ways such as for example by allowing users (based on user emotional input (see FIG. 7) or automatically using a variety of devices or systems such as emotion processing systems) to embed user responses into content in order to reflect how users are feeling at one or more points of their consumption of the content or materials. This aspect of the content engagement platform (22) allows for example the capture of information relevant to learning objectives such as specific aspects of resources that may have provoked inform hot spots, excited learning, confusion, boredom, upset, etc.

Various technologies may be used to harvest and analyze user responses including but not limited to (A) a plurality emoticons that can be selected by a user and associated with a resource or portion of a resource using an input means, as shown in FIG. 7, and (B) a facial recognition system that includes or links to a camera detects to capture facial images and analyze them to infer emotional state.

Also, the content engagement platform (22) can be used (including by relying on information from one or more graphic user interfaces or sensors) to capture emotional-response indicators thereby tracking and optionally displaying learner/user emotions that are based on and indicate important feelings linked with changes in thinking, understanding, and inquiry. These emotional-response indicators can be used to add relevant context to resources, for the user whose feelings have been captured and for other users as well. This information may be used as part of the filters used in the GT (12) or the ST (14) in order to add other dimensions for discovery and processing of resources.

The emotional-response indicators may also be used by teachers and learners to see, track, and engage with high or low response areas, ideas, or resources in the platform (10). For instance, students may be asked to identify feelings during particular activities or when engaged with particular content. The platform (10) in one implementation may provide a graphical user interface that shows the areas, ideas or resources where emotions are highly perplexing or intensely surprising and this may trigger a response from the platform (10) such as a notification to a teacher ore student to address these emotions for example by responding to them and engaging with the users who have expressed this emotion.

Also, a certain amount of confusion is associated with greater learning. Teachers will be able to see when students experience confusion, what happens when they do, how much confusion is generative and how much is too much. Accordingly, the platform (10) tracking of emotions will help students and teachers to customize or improve content, activities, assignments, and ultimately learning.

A key aspect of the invention, is the particular ways in which GT complements ST, and vice versa, and also particular workflows that are based on the user accessing GT/ST for specific purposes, and depending on whether the user is a student or a teacher, in the case of an e-learning implementation of the platform. Further details regarding possible workflows that involve users switching between GT and ST and vice versa are discussed below.

The ST allows users to access content related to a particular sub-domain such as a course in a collaborative manner

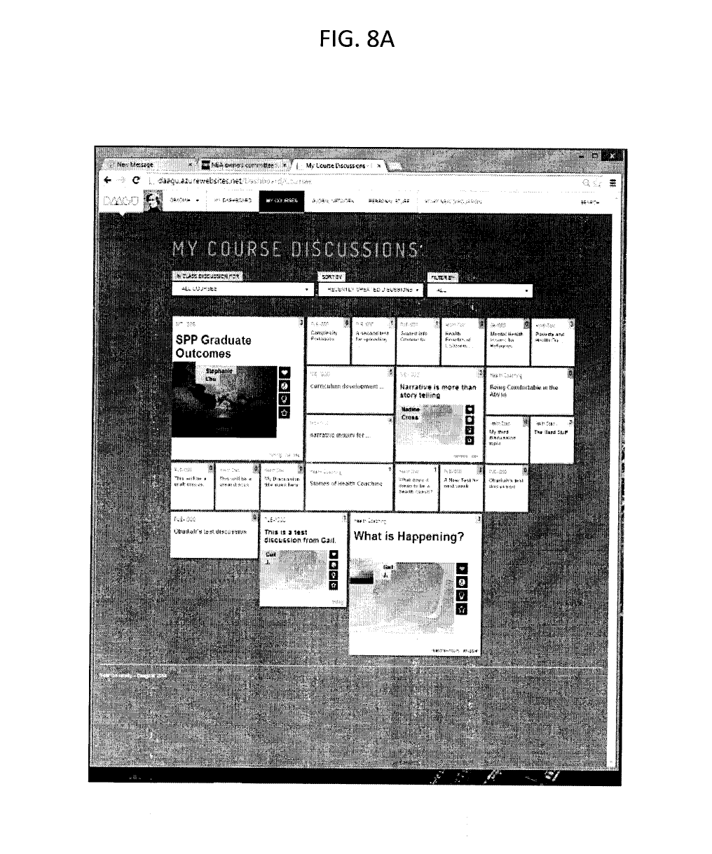

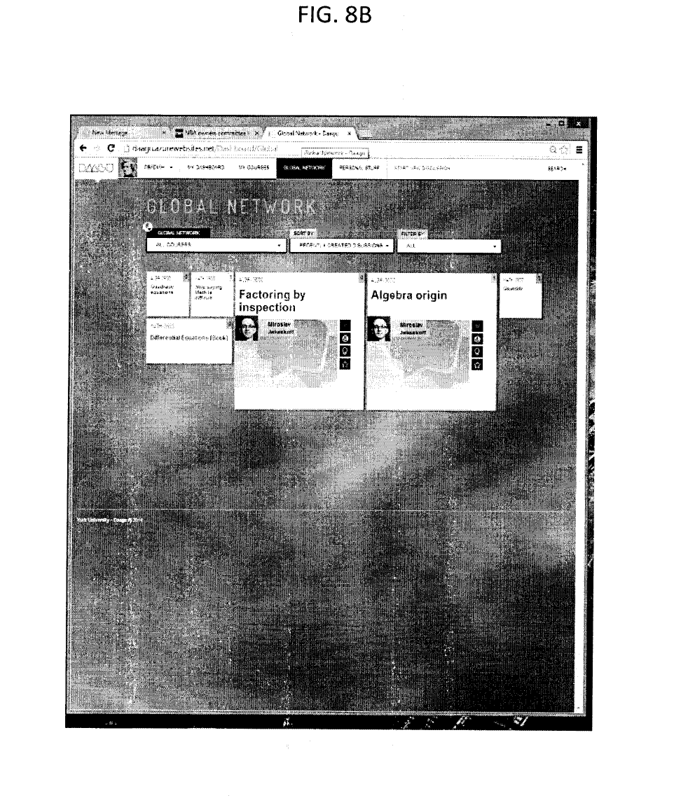

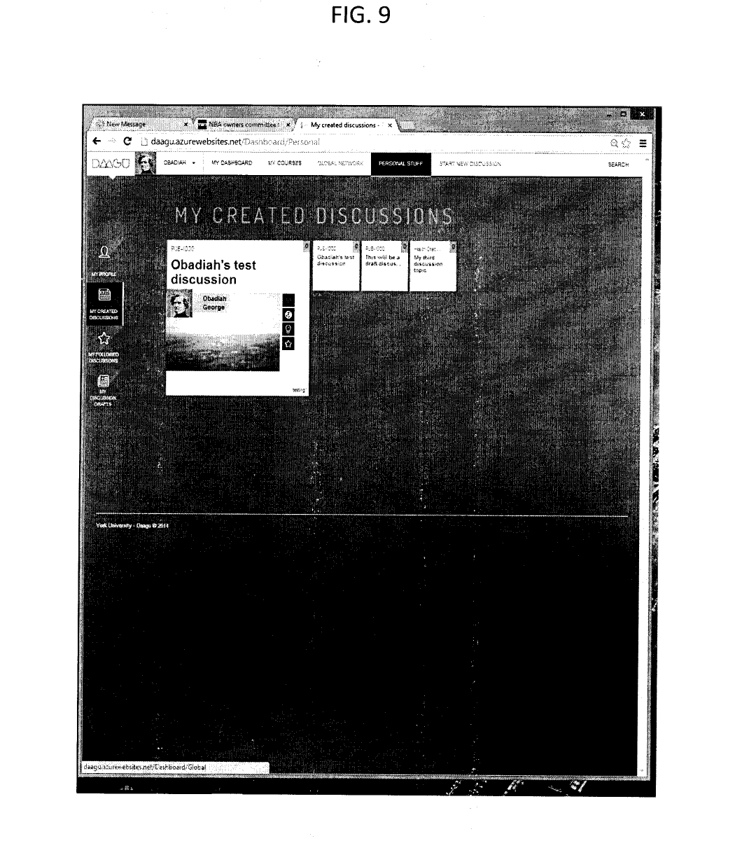

Significantly, the GT is integrated with the ST; and the GT allows users to access one or more global views of content related to a domain (optionally associated with the sub-domain in ST), based on a visual display of a relatively large number of content items using a set of rules for representing associated content attributes using visual parameters (“visual content indicators”). For example, one or more perspectives may be associated with a set of content items. A visual parameter such as symbols and/or colour may be associated with each “perspective”. The GT may include an arrangement of symbols associated with the content items, presented in a navigation graphical user interface (“GUI”) which may for example be arranged in a grid or heat map such as is shown in FIGS. 8B and 8B. FIG. 9 illustrates a representative graphical user interface for accessing the functions of the ST, wherein in this particular example, all discussions a user has created or tagged to follow is displayed in grid format as a heat map.

The GUI may include a selector (which may be implemented for example as a series of tabs) that allows a user to switch between content attributes, for example switching between perspectives, thereby initiating a change in the display of the visual parameters. In one aspect, a symbol representing a content item remains static, while associated visual parameters such as colour change depending on input to the selector.

Accordingly, GT supports a workflow wherein a user can (A) view a series of icons representing content items, (B) discover additional detail regarding content items for example by dragging a cursor on a particular icon, and (C) selecting one or more perspectives, thereby initiating change in the visual attributes (such as colour) on the display of one or more of the icons; wherein depending on the selected perspective, specific symbols that share the same or different visual attributes change, and these similarities or differences define patterns that can convey relationships between content items that may be discovered by the user across a significant number of content items. These relationships may initiate the user to direct their interest to ward accessing additional detail regarding selected content items.

Use of GT (12) in accordance with the workflow, allows teachers and/or students to discover content that may be relevant to the sub-domain in a more efficient and flexible way that is consistent with emergent learning.

Content items discovered using GT (12) may be promoted to ST (14), and also annotated by users in a variety of ways, using for example the content engagement platform (22).

For example, students may encounter critical questions in a course (which may be proposed by teachers relating to desired learning) and some content (from the GT (12) and as may be uploaded by teachers) that defines the boundaries or constraints for launching an inquiry further refined by the student's own questions about a course topic or subject. The learner ventures into content on the GT (12) or using one or more associated online tools, in order to pursue answers to his/her particular questions. As previously stated, the platform (10) supports the student in gathering multi-media artefacts (text, video, images), and also commenting on the relevance of the artefacts for example in a text box, and organizing the materials gathered in a personal space, which may be the ST (14). Thereafter, the teacher and student can use the platform (10) to examine, reflect on, and converse about materials gathered in the student's personal space. This tool will allow recursive reflection between instructors and students as well as students and other students.

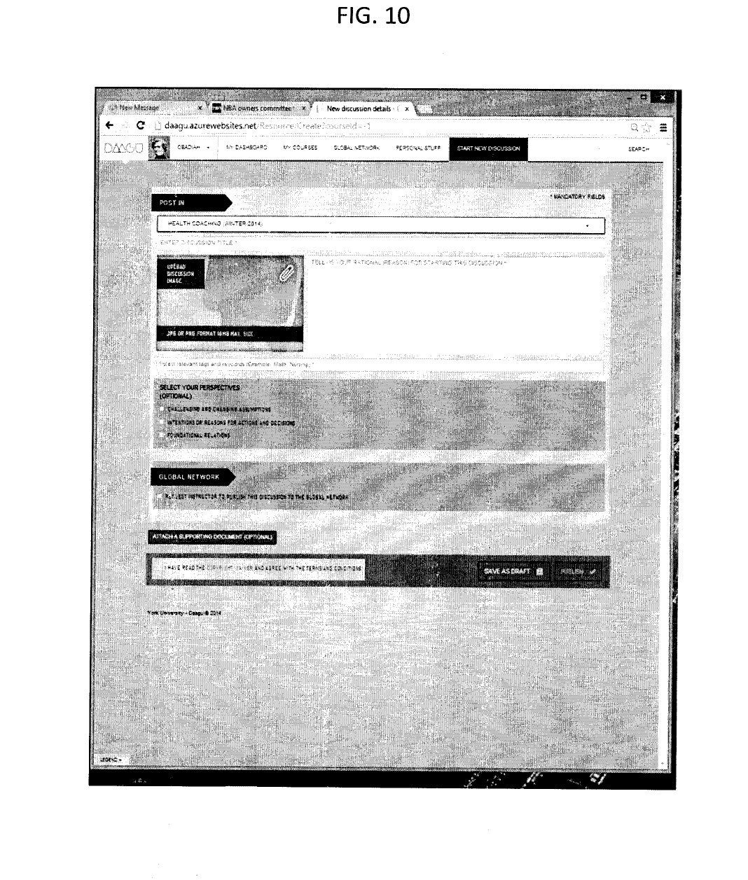

FIG. 10 illustrates a representative graphical user interface for a user starting new discussions destined, for example, for a particular course, the ST or for the global network, GT or other location, wherein the user may associate an image with the discussion, link the discussion to perspectives, attach resources or save the discussion draft for later. The ability to create discussions may be inherent to any user, however the ability to create certain discussions in specific locations, for example in a specific class or course, may be enabled by an administrator using, for example an invitation code circulated to users authorized to create discussions in that space.

The platform (10) provides a solution that provides practical access to trans-disciplinary, multi-media content that is open to all learners through multiple filters.

The platform (10) can provide new mechanisms for learning activities across disciplines. For example, 15 faculty from five disciplines (health, law, women's studies, education, and fine arts) in collaboration with local community partners can create a trans-disciplinary repository on social justice. Each of these original creators may have populated the repository with content in the GT (text, images, videos) that are believed important for understanding social justice from a particular perspective. The GT enables all users to see the key works and perspectives considered by this group. Users can add key words and perspectives to the social justice repository. All faculty can send students to the GT with their own personal or group questions. The students go on a quest in the GT and can gather materials from the GT or the Internet into their personal spaces for reflection. Upon reflection, these students may use the GT to further add context to resources, for example by adding perspectives, annotating content, adding related content and so on.

An important contribution of the inventors is a computer system and computer implemented method that promotes emergent learning processes through the interplay of content, diversity, and collaboration.

The platform (10) provides a unique online environment that facilitates, and tracks, emergent insights—or “aha moments”—within a teaching-learning environment.

The platform (10) provides insights and new learning that may not have been otherwise possible by providing an easy to use, engaging and scalable platform that facilitates cross-disciplinary inquiry in a way that was not possible before.

Examples of possible interfaces for implementing the GT functionality are shown in FIGS. 8A and 8B. A possible interface for ST (14) is shown in FIG. 9.

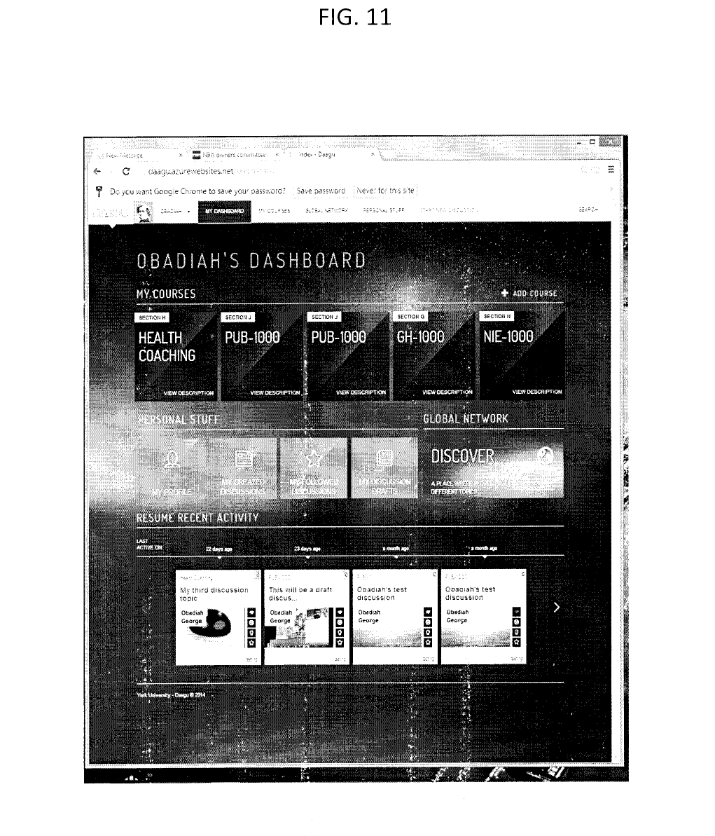

Users logging into the system may be greeted by a landing page providing access to applications of the platform (10) enabled for their access by administrator, if desired, as illustrated by an example of such a landing page in FIG. 11. Users may be able to access various courses, the GT or ST and content and discussions contained therein, as well as identify and access recently accessed discussions. Information and content may be presented, for example, by grids and/or images, text, colour and shape.

In one aspect of the invention, a system and method is provided for a learning platform implemented as part of a social networking platform that is implemented as a part of a computer network service, that is configured to enable social interactions consistent with social, cognitive, teaching and learning presence to improve learning outcomes.

The platform (10), may enable users of a community of a social network to engage in multilevel discussions, and synchronous/asynchronous/instant messaging to create open dialogue and/or discourse of resource/ideas/learnings pertaining to a given subject matter, said dialogue and/or discourse adhering to four separate elements used to create a deep and meaningful (collaborative-constructivist) learning experience. The four separate elements are social, cognitive, teaching and learning presence, and will be described in greater detail below.

Community members may be teachers and/or students of the same class and/or course, teachers and/or students of the same or similar faculties or disciplines, researchers in a given field, and any combination thereof. Discussion amongst and between members of the given community will be prompted, encouraged and guided consistent with the principles contained by the four elements.

For example, members of the community may encounter critical questions in a course (which may be proposed by teachers relating to desired learning) and some content (from the GT (12) and as may be uploaded by teachers) that defines the boundaries or constraints for launching an inquiry further refined by the user's own questions about a course topic or subject. As previously stated, the platform (10) can support a user gathering multi-media artefacts (text, video, images), and also enable commenting on the artefacts (for example in a text box), and organizing the materials gathered in a personal space, which may be the ST (14). Thereafter, community members in the social network may explore and engage with the gathered materials and associated commentary in each other's' GT (12) or ST(14), or alternatively in a selected community-wide GT (12) or ST (14), using the content engagement platform (22),

Inquiries presented by the content engagement platform (22), each corresponding to one of social, cognitive, teaching and learning presence, can guide a member of the community, for example with a prompt and/or interactive text box, as they explore another community member's materials. The content engagement platform (22) can enable users to provide additional commentary, engageable by the community as a whole or specific members or categories of the community, for example only students taking a specific course. The content engagement platform (22) may be configured to enable community members to provide additional commentary on a member's materials and commentary, facilitating discussion and discourse between members of the community on the subjects presented in the materials, comments and commentary. The cumulative effect of inquiries may lead to adjustment in a variety of elements of the learning platform, including but not limited to content, materials and course design.

Regarding the inquiries presented by the content engagement platform (22) to community members, teaching presence may focus on course design and organization of materials facilitation and direct instruction. Social presence inquiries may focus on communication, the social network group cohesion and belonging, affective expression, and purpose or intent. Cognitive presence inquiries may focus on triggering events (activity/question/comments, for example), exploration, integration, and resolution. Finally, learning presence inquiries may focus on learner approaches and considerations in both an individual context and in a social context including but not limited to, setting learner goals, identifying obstacles to completion of work and learning, taking initiative in group work, sharing with and helping classmates, identifying areas for improvement, and asking for help.

The four elements will enable users of the platform (10) to create deep and meaningful learning experiences based on the communities of inquiry to improve learning outcomes.

In one aspect of the invention, a system and method is provided to structure enabling-constraints, pose critical questions for inquiry, enable learner choice for personalized study, provide multiple nodes for shared engagement and interaction (feedback), enable multi-media inputs, provoke perturbations, increase diversity of view, link emotions with patterns and points of connection.

Pedagogical interactions may be structured to occur across and among students and teachers within a field of inquiry that sees knowledge as potential for acting and problem-solving within a community. The pedagogy shows how critical thinking can happen in community in exciting and engaging ways. All persons in the community contribute to the curriculum as it emerges from contributions of the group. The pedagogy seeks diverse views and perturbations with the goals of sparking new insights and learning. The pedagogy is collaborative, open to new directions and possibilities, meaningful to the group involved.

The platform (10) provides an interactive platform for organizing relevant content for a given purpose. The platform (10) enables this content to be customized by users/viewers according to multiple views/tags. Significantly, the combination of emergent learning, and ability of users to easily and intuitively add content to a repository (16) (and optionally add context to such additional content using the content engagement platform (22)) enables a field of content to be grown organically so that content expands and increases its usability and accessibility for future learners/users.

The platform (10) enables the consumption of content in within a “field” of content in multiple forms of media, using a user interface that is visually appealing, and accessible.

The platform (10) allows the capture of the aha moments when students experience a shift in their views and understandings, allowing teachers to use this information to enhance the learning experience (whether by creating new content, changing courses, further annotating content etc. For instance, a student exploring the relationship among poverty and health learns about how the stress of not having enough food, shelter and money impacts health. The student learns that stress changes blood pressure and that people choose different priorities when living in poverty. The student finds a story about a woman who knows that she is a diabetic but she cannot afford healthy food to help her three children to feel satisfied. She can buy a large pizza for $4.99 but not enough fresh vegetables and fruit to take hunger away. The link between poverty and stress directs the student's attention to the role of stress in diabetes and suddenly the student sees for the first time that diabetes may be more connected to poverty than lifestyle. The platform (10) asks students to upload their insights with an explanation and possible attachment of resources so that other students and the teacher can see how the student extended learning about the relationship of poverty and health. Insights herald deeper learning and enable students to transfer learning across multiple contexts. The teacher can further extend the transfer of learning by asking students to consider relationships among poverty, culture, and diabetes, especially among Canadian Aboriginal populations where before 1952 there was no diabetes. Students tracking their own learning will see how their “aha” moments change their understanding. Students who see others “aha” moments will also have the chance to extend their own understanding in new ways and to better converse about complex issues. The platform (10) will visually show students their learning pathways according to concepts, essential understandings, and aha moments.

### DISCUSSION

The present invention is designed to be aligned with foundations of complexity, in which we see critical thinking within four specific processes: connecting perspectives for deep learning, attending to emerging insights, transporting ideas across contexts (multi-vocal & multi-perspectival), and imaginative re-visioning in community. These four processes of critical thinking have been informed by complexity science, Doll's (1993) four Rs, (Richness, Recursion, Relations, and Rigor) in particular, and concept-based learning.

First, consider the process of recursion which can be thought of as a revisiting or re-engaging with content with new eyes. Revisiting with new eyes is how to understand changes. The technology will enable this process of recursion in the personal spaces of students—in their written journals and notes where learners will be recording their recursive thinking.

Collaboration is also directed at achieving a certain level of complexity or diversity that is required in order for thinking (for individuals and groups) to transform to new levels. With the right amount of complexity, learners shift thinking as novel ideas emerge in the play of difference. The technology will enable this kind of collaboration by providing teachers with games and/or puzzles of various kinds that require learners to contribute different answers or ideas. The teachers can select games/puzzles according to the number of different views desired. For example, one picture puzzle might be solved when 6 students enter different ideas. Once the picture puzzle is solved the students are engaged in an activity that requires them working with all six ideas in order to come up with new solutions.

This first process is evident when collectives of students express how particular concepts, ideas, or questions relate in expanding (perspectives of) relevance and potential application. Perspectives represent nodes within networks for thinking about how to deepen ideas by relating the ideas in increasingly diverse webs of relationality that highlight intersections as well as diverging meanings and interpretations. For instance, students in a health course discuss the medical diagnosis of dementia as a disease process, a socially constructed illness, a myth, and a stigmatizing reality, an opportunity for growth, an ethical dilemma, and a drug company's dream. They pose questions about societal values and moral obligations. Some students present art works depicting images and experiences that range from the horrific to the sublime. The network of intersections and diverging portrayals of dementia enable students to make connections that deepen what might have been a limited understanding of dementia while at the same time expanding questions and possibilities for additional exploration and dialogue that clarifies interpretations, social responsibilities and ethical implications for society.

### Attending to Emerging Insights

Emergent insights are represented by student expressions of aha moments, new awareness, shifting perspectives, and perplexing questions. Emergent insights are similar to the bifurcations described in complexity science and they help illuminate the ways that students build on prior knowledge and understanding in order to move forward in differing and clarifying ways. In some respects, emerging insights are indicative of the convergence of the three constructs—CT, metacognition, and reflection. Emerging insights represent thinking in motion, the growth of understanding, and the interplay of CT, reflection, and knowledge extension. Consider an example of an online student discussion about diabetes and social justice. One student shared her understanding of the relationship between poverty and diabetes. A second student extended the relationship by adding a node and some views about political and social policy and poverty.

A third student then contributed an insight of how diabetes in a First Nations community was directly linked to poverty, accessibility, government policy, and loss of traditional life. She offered her insight and posed the following question to her group. How do our personal politics impact on persons living with diabetes?

### Transporting Ideas Across Contexts

The transportation of ideas across contexts enables an in depth exploration of one abstract concept or construct across multiple interpretations and contexts. The layering or laying down of different understandings to one particular concept is a recursive activity that helps establish patterns of thinking and being. This transporting process encourages a thoughtful inquiry for complexity, ambiguity, and nuance as understanding/meaning of concepts shifts in light of different contexts. A fractal like pattern of understanding emerges with iterations and elaborations. For example, a community of students begin an inquiry about loss and grieving. Each student initially pursues a web quest seeking to understanding loss and grieving within a particular culture. Students may choose an intimate look at how one family grieves or they may look for patterns of loss and grief in distant cultures. Each student returns to the group with a narrative story depicting lived experiences of loss and grieving. The teacher engages with the group and their narratives and requests that they complete a border-crossing activity to the Fine and Performing Arts discipline in order to collect artistic representations of loss and grieving. Border-crossings encourage students to step over disciplinary or conceptual boundaries in order to see what discoveries might be inspired in the unfamiliar terrain of different thinking. Students return to community with images, music, and performances (video) representing loss and grieving. Questions posed in the group include: What did you learn about loss and grieving that surprised you?, and How will your new understanding change how you act with others who are experiencing loss and grieving? In this way, students layer deep understanding of how loss and grieving are expressed and represented across cultural and disciplinary contexts.

The process of imaginative re-visioning happens in a space where students are asked to turn ideas upside-down and inside-out in order to imagine a different way of thinking or acting/being. This process is inspired by the belief that with sufficient diversity new ideas will surface in the spaces or ruptures created by the gaps, differences, and intersections of ideas in community. Students might consider questions of What if? How might? What would it take? The imaginative re-visioning might involve a group project about an issue that requires new approaches. For instance, a group of students was asked to view six digital stories created by women living with disability and difference. In the stories women describe their experiences in a health care system that regularly denies them access, minimizes their concerns and health issues, and accentuates the damaging stigma of difference and disability. The student group is asked to discuss the stories, agree on key issues, and develop a new health system that would better serve women living with difference and disability.

The four processes referred to earlier will inform the process of creating e-learning tools that inspire and enable critical thinking within spaces of community inquiry.

### Implementation

The platform (10) may be implemented as a computer network implemented system. In one representative implementation, the platform (10) includes a server (16) (or a server farm) and a server application (18) (which may be implemented as an application repository) that may include one or more software utilities for enabling the features and processes of the present invention. The platform (10) may be configured to provide online access to various features and processes implemented by the server application (18) from a variety of network-connected devices (20) including desktop computers, tablet computers, or smart phones, as further explained in this disclosure. The server (16) is also linked to a database (22). It should also be understood that the platform (10) may be implemented using a cloud computing platform, and also may provide SaaS (Software as a Service) based services.

The platform (10) may also be implemented as an enterprise server, with a server deployed for each institution. Alternatively, the platform (10) may be implemented using a multi-tenant architecture. The system may include an administrative utility (34) that allows users with administrative access to determine access to various system functions, databases, data services associated with the platform (10), including hierarchical access to particular users. The administrative utility (34) may be used for example to: (A) register students to the system, (B) register instructors to the system, (C) assign instructors to a course, (D) make sure that students registered to a course appear in the course, and (E) allow management of system resources.

The GT (12) may be implemented using for example the SILVERLIGHT™ technology of Microsoft Corporation, which is a pivot viewer that gives a visual display of resources uploaded to the system. This pivot viewer can permit the dynamical filtering of resources. Without being limiting, GT (12) may alternatively be implemented using cross platform, cross browser data visualization tools that enable users to see data, filter it and identify relationships. For example, such a cross platform, cross browser tool may be HTML5-based.

FIGS. 8A and 8B illustrates a possible user interface for enabling users to access the functions of GT (12).

In one possible implementation: users login to the GT, or a specific portion of the GT assigned to a group of users; users filter through a number of options which may be referred to as “facets” and in this embodiment are shown on the left side of the viewer; users can zoom in or click on a particular resource; optionally on a right side of a particular view or “pivot” meta data for the selected resource may be displayed; double clicking on a particular resource may open up a new page showing further details of the resources.

In one possible implementation, there may be a “student point of view” and a “teacher point of view” as part of the GT. The student point of view may enable students to access resources, according to a perspective, defined by one or more teachers. The student, however, can then filter these resources and select one or more resources. The student can then act on resources that they have selected, for example by adding them to their ST (14) or for example using the ST (14) to open a conversation for the resource.

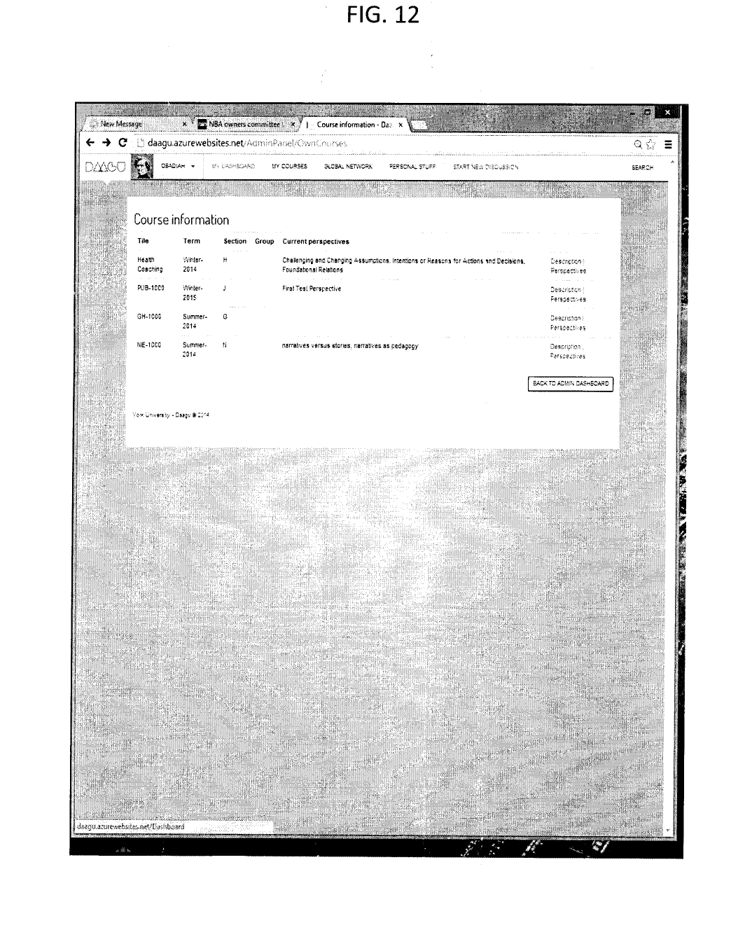

An instructor on the other hand, one on implementation can: upload resources to GT (12); set perspectives, for example for a “class”; delete or modify resources; delete or modify perspectives; optionally add a global (open) conversation to a resource. FIG. 12 illustrates a possible user interface for enabling an instructor to set perspectives or create course descriptions.

The ST (14) is the area or utility of the platform (10) where the most of the work is done by the students. ST(14) may be configured to allow students to engage in a range of activities including: (A) gathering resources and working towards a goal either individually or by team; (B) access a list of courses of the student through the platform (10); (C) select a course; (D) access and manage resources related to a course such as adding, modifying, deleting resources, viewing content of resources (including through a folder system), share or duplicate resources; (E) interact with content such as view public comments, participate in discussions, add notes, make an entry in relevant journal space and so on; (F) work on one or more assignments whether individually or as a group; (G) access visual objects to enhance the learning process such as transformers, digital origami and so on; (H) access one or more encoding tools such as tools for logging emotional perspective, or (I) managing information captured by such tools; (J) accessing one or more reports or maps such as for example a mind mapping for students to see how their own thinking has grown and how their patterns look like compared to other students.

In one implementation, when a student user accesses the platform (10) and more particularly accesses ST (14), this may present in a way that is similar to the GT (12), but reserved for the student as explained herein.

The content shown is determined by the student and the class they are enrolled in, and the only resources that the student may view through the ST (14) may be the ones in their particular class LC. The ST may be referred to as “learning cart” as it contains resources relevant to the student, and within that to a class that a student may be taking, however, the student can still direct aspects of the content included and furthermore user directed filtering of content (much as in the GT (12)) is also enabled in the ST (14).

Resources accessible through the ST (14) may not be “global” but rather are private or semi-private for example as per the applicable policy. Facets in relation to ST (14) may be a list of resources, but only for the class place; a list of titles that the student is enrolled in; perspectives may be only those associated with resources available to the students in the class. Filtering may be available through ST (14) (much as it is through GT (12), except in relation to the sub-domain defined for the ST (12) whether by the teacher or the student(s)).

The ST (14) may include various other features such as: (A) automated creation of a note, journal or threaded discussion when a resource is added to the ST (14)—in one possible implementation adding a note to a resource may be made mandatory; (B) uploading of content to the ST (14); (C) each resource may be associated with an option of being promoted to “Class Space”—when promoted, the resource is shown to everyone in the class including related content such as notes or discussions; (D) when a resource is moved around within the ST it is duplicated thereby enabling resources to be mapped to different domains or sectors; (E) resources can be promoted as well as “demoted”; (F) promotion of a resource carries with it related content such as notes or discussions and this related content is automatically published to all users whose ST (14) now includes this resource; (G) students may submit a resource for evaluation to a teacher through the platform (10); (H) students may share resources or related content with other resources; (I) the platform tracks all actions such as additions, deletions, and contributions and may use an analytics engine (24) to generate insights or track trends.

A specific type of resource may include an “understanding” which may be for example a key word relevant to a resource such as an insight, aha moment, new light, and deeper knowledge. These understandings, in one implementation, may be displayed separately from the ST (14) for example in a repository.

The ST (14) may include a variety of tools that allow students to organize resources, including by creating bags or folders of resources. These may be shared as well with a teacher or students.

In one possible implementation, notes are associated with a character limit (such as 1024 characters) and are modifiable by the user creating the note.

In a possible implementation, a journal is a personal resource that may be shared with a teacher, and even then at the option of the user controlling the journal, and journal entries may be added to but cannot be deleted.

In a possible implementation, when a resource is shared for discussion, this initiates multi-level, threaded discussions where discussions are generally non-erasable.

An ST (14) or learning cart may also be shared for example within a team, i.e. providing team learning carts (“TLC”). Various possible rules may determine the management of team learning carts. For example two or more students may be required to create a team learning cart, and a teacher may be a default member of the team learning cart, where no individual student can delete a team learning cart. The teacher may play an administrative role and have permissions in the platform (10) to: delete the TLC, add/delete the resources completely from the TLC, and add/delete folders from the TLC, add/remove students from the class to the TLC, close the status of the TLC, or modify notes. A student creator for a TLC may for example have permissions in the platform (10) to: create and add to a TLC, invite other students from the class to the TLC, remove team members from the team, accept requests from other students from the class to join a group, set the status of a resource or a folder for marking or for deletion, change status for the TLC to open or close, or modify notes.

Student members (not creators) of a TLC may have all the same permissions as a student creator, except they cannot remove members, and they do not receive requests to join the TLC from other students.

Various other or different policies or rules are possible. For example, a TLC may incorporate one or more mechanisms or tools for members to develop consensus, for example a voting tool.

One higher level of abstraction, but similar to a TLC, may be a “class space”, which may be a common area for students and an instructor in a class. A class space will generally have a student area with student associated features and a teacher area which may be implemented as an administrative or management interface with a set of tools that allow a teacher to manage various learning activities and resources.

The student area may for example list the various TLC's of the student, a list of learning cars for the student which are shared with the professor, a list of submissions by the student, a list of their understandings, student information such as their first name, last name, username and student ID. Other pertinent information may be included or link to the student area such as a class list, syllabus and so on.

Through the teacher area, the teacher may for example: show all of the TLCs for the class (for which the teacher is the default owner); create a new TLC; when clicked show the details of TLC (which may include for example the title, description, number of students, and list of the students in the TLC and the structure of the TLC, i.e. the resources and the folders inside the TLC); within a particular TLC add/remove resources, add/remove students, and create folders; and change the team lead i.e. the student owner of the TLC; a list of LCs which are shared with the particular teacher, including the title of the LC and associated student's name; links to student submissions (which may include submissions in regards to individual assignments or team assignments).

Various different applications are possible. For example the platform may be implemented: (A) as part of an online educational platform, (B) a corporate training platform, (C) a decision support platform where decision making is supported by promoting understanding of concepts, and interaction between users regarding concepts, (D) an online coaching platform, (E) any other platform that involves content creation, content distribution, or engagement with the content, where the present platform or integration of one or more of its features provides better understanding of the content or learning of the content.

### Content Management

The platform (10) can be integrated with various 3rd party online education platforms that make available “massive open online courses” such as (EDx, Coursera, Udacity, Khan Academy) and also Learning Managements Systems (such as Blackboard, Moodle, Sakai) in order to add second generation content capability to these existing systems.

In one aspect of the platform (10) the server application (18) includes or is linked to a web presentment utility (30) for supporting various operations related to publication of web areas or web pages in connection with providing access to functions and features of the platform (10). The web presentment utility (30) may incorporate for example functionality for generating platform client dedicated web areas (32) by co-operating with an administrative utility (34) of the platform (10) for restricting access to web areas dedicated for example to one or more particular platform clients or learners associated with one or more particular platform clients, for example based on administrative settings and permissions defined by an administrative user using an administrative interface presented by the administrative utility (34).

In one aspect, the platform (10) may also enable platform clients to define shared activities and resources based on one or more collaborative features that may be implemented using the administrative utility (34).

The system may also be implemented, or be implemented in part, as a mobile application which when executed on a mobile device implements one or more of the features described the invention.

The system may include or link to various other complementary system, applications or services. For example the server may include or link to a gaming utility that is used in order to gamify learning functions through the platform (10).

### Use Cases

In one example of possible implementation of the technology, the present invention is explained by referring to the use of the platform to promote emergent learning in regards to a particular area of inquiry, namely a hypothetical course regarding “social justice”. In this example, the social justice course may be offered to undergraduate or graduate post-secondary students from a variety of disciplines including, but not limited to, Health, Education, and the Fine Arts.

This use case also illustrates how the present invention fulfils the requirements of complexity-based pedagogy to support learner-focused, concept-based, emergent learning in a trans-disciplinary setting.

Social justice is a broad and complex subject making it ideal for a trans-disciplinary curriculum. This relatively recent idea has been broadly defined as justice between individuals, and emerged in Western nations during the industrial era struggles to improve the conditions of people's lives (United Nations, 2006). Social justice is now seen as relevant to humanity and human dignity on national and global dimensions. Indeed, the notion of social justice is woven throughout various academic disciplines, which can frame social justice in terms of different dimensions of inequality. For example, in the area of education for health professionals, discussions of social justice may center on reducing healthcare-related inequalities; new teachers may be prompted to consider how to achieve and promote maximal inclusion in the education system; and students of the Fine Arts may explore the role that art plays in educating others about social justice. As there are a variety of theoretical frameworks and vantage points from which to describe and define social justice, and therefore illustrates the advantages of the present invention.

In one example of use of the present invention, the course may include an initial exercise where students may be asked to reflect on currently held beliefs and assumptions regarding social justice, from both a personal view point, from the frame of a learner in a particular field of study, and from some essential understandings put forth by the teacher. Essential understandings may include: social justice is a moral imperative; social injustices create marginalization and ‘othering’ processes. This reflective exercise can be experienced as a first step, prior to doing any reading or research, to encourage students to explore pre-existing assumptions or beliefs. As well, an initial common learning resource may be suggested as a reading to aid students in this individualized reflection. For example, students could be assigned the document Social justice in an open world: The role of the United Nations (United Nations, 2006) as a shared reading and then be asked to reflect on their responses to this reading. Following reflection on the reading, students would be prompted to further explore how social justice is described and represented in their particular field of study. A way to engage in this exploration is for students to identify one or more relevant learning resource(s) that they find through personal multi-media exploration of the World Wide Web, and extant literature, for example. This exploration of a concept across multiple disciplines aligns with the processes of connecting perspectives for deep learning and building richness of content and interpretation.

Complexity learning encourages participants to explore a variety of modes of knowledge in order to challenge more traditional linear approaches to education. For example, students may provide links to open educational resources such as Harvard University's Justice with Michael Sandel video lectures and discussion forums (http://www.justiceharvard.org), academic articles describing the relevance of social justice to a particular profession, or to relevant artwork such as the permanent The Struggle for Justice exhibit of the Smithsonian National Portrait Gallery http://www.npq.si.edu/exhibit/struggle/index.html). By sharing their resources, students will contribute richness to the curriculum by interposing content that allows social justice to be examined from a variety of perspectives. Moreover, this activity will also provide raw materials for enhanced curricular relations and border crossing as students may then explore the diverse set of resources added by their classmates

Collaborative dialogues regarding the initial resource gathering are facilitated by the teacher who offers critical questions for the students to consider. What are the tensions and contradictions found in the contexts of social justice? How is poverty an expression of oppressive social structures? What unique, unthinkable collaborations and partnerships could make a difference to living social justice? Students are asked to keep a journal of their aha moments and shifts in understanding.

Each student will have arrived at the dialogue with his/her personalized exploration of the topic through individually selected resources and personal reflections. These discussions will bring together a variety of viewpoints from which to further discuss social justice, and will prompt students to re-visit and re-question their previously held assumptions and beliefs. These perturbations will enhance the recursive layering by prompting students to re-reflect on what social justice means to them and including additional exploration of the meaning of social justice from both within and external to the course content and processes in an ongoing spiral. The curriculum processes provide for continuous recursion and emergent learning about the concept and experience of social justice.

The cycle of recursion—reflection, exploration and collective meaning-making provides an example of how the complexity-based pedagogy may begin to prompt students to think critically about what social justice means and how it is witnessed and lived out in different communities. Teachers enable students to explore ideas through their own personal interests and preferred paths of inquiry. Following reflection on personal assumptions, course activities set the stage for the identification and subsequent in-depth exploration of related/embedded concepts central to social justice and of personal interest to the students. The learners' awareness of their own thinking through the recursive processes, and critique of assumptions relating to others' views exemplify the metacognitive dynamic needed for critical thinking.

A skilled reader will understand that the platform (10) may be implemented using a variety of different learning workflows, and a variety of user interfaces facilitate the user interactions described herein. What follows is an example of an emergent learning application implemented by the platform (10) based on interplay of participants through the collaborative functions of the platform (10).

A teacher may pose a general question such as “How does poverty change health?” In response the platform (10) may display to one or more students, using a graphical user interface, 6 shapes that requires answers. Once six shapes have responses, they may come together to form a new shape. Now, students may be asked to answer a new question that addresses all 6 ideas presented in the first activity. For example, “When you look at all 6 ways that poverty changes health, what are three things you would do if you were the Director of your local health clinic.” When students record three actions, the platform (10) responds with trigger that may be defined for example by one or more incentives or games linked to learning in the platform (10). For example, the platform (10) may initiate a transformation to a digital object. For example, a book may be displayed but this turns into something more fun upon completion of an emergent learning objective. A gaming utility may be linked to the platform (10) or made part of the platform (10) and may tie games or puzzles to desired actions such as interplay of student ideas with teacher questions. Students could also create games and puzzles for their groups or class mates.

In another example, a group of individuals who share a common interest in a specific subject may be inclined to form a focus/research group to further educate themselves on this subject. One issue may be the group's ability to collect, compile and organize publicly or privately available data that exists on the Internet in an easy-to-understand manner. Currently available, social collaboration tools, like Chatter and Perltrees, generally have rigid data structures that do not allow for recursion or complexity-learning. The platform (10) permits these individuals to seamlessly aggregate all resources that pertain to this subject matter and interact with each member of the group regarding each resource in order to augment their knowledge base as it pertains to this subject.

In another example, business entities such as law firms, accounting companies, financial institutions generally use some type of networked database that may be organized according to client accounts, such as for example document management systems or knowledge management systems. These business entities currently deal with data management inefficiencies when trying to identify specific attributes or data across one or more client accounts. The platform (10) permits the account managers of these business entities to quickly assess and learn intricate details from one or more accounts through the use of the GT. Likewise, these account managers could manage their own LC that is formed based on common traits associated to one or more accounts in an attempt to determine additional products or services that may be of interest to their clients.

It should be understood that the technology described in this disclosure may be used to in conjunction with a variety of platform for example to enhance the ability to sift through information objects such as documents, including in a collaborative manner.

The platform may include conventional known social networking features. For example collaborative learning features may be implemented, or implemented, in part using social media interactions through a social networking platform, or learning events through the platform (10) may be used as the basis for social media feeds shared through one or more third party social networking environments.

In this way, the platform (10) may create connections between learners that may not have occurred otherwise. For example, the platform (10) may be configured to match different learners that are being challenged with different aspects of the same content, yet may be well suited to assist one another so that they can each complete different learning dimensions related to the content. This aspect represents a significant innovation over existing learning platforms and existing social network environments.

### General Implementation

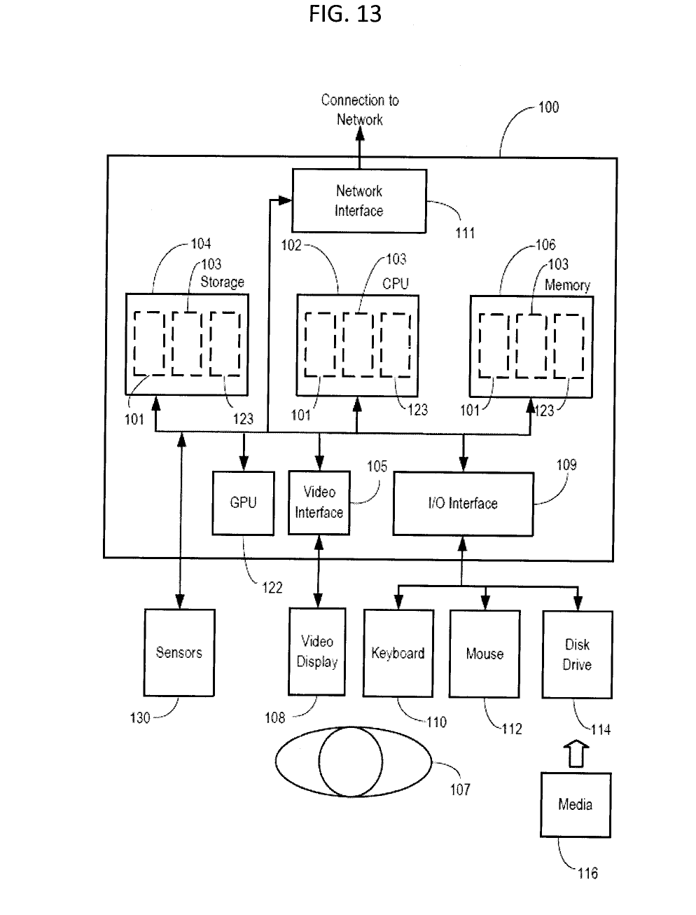

The present system and method may be practiced in various embodiments. A suitably configured computer device, and associated communications networks, devices, software and firmware may provide a platform for enabling one or more embodiments as described above. By way of example, FIG. 13 shows a generic computer device 500 that may include a central processing unit (“CPU”) 502 connected to a storage unit 504 and to a random access memory 506. The CPU 502 may process an operating system 501, application program 503, and data 523. The operating system 501, application program 503, and data 523 may be stored in storage unit 504 and loaded into memory 506, as may be required. Computer device 500 may further include a graphics processing unit (GPU) 522 which is operatively connected to CPU 502 and to memory 506 to offload intensive image processing calculations from CPU 502 and run these calculations in parallel with CPU 502. An operator 507 may interact with the computer device 500 using a video display 508 connected by a video interface 505, and various input/output devices such as a keyboard 510, mouse 512, and disk drive or solid state drive 514 connected by an I/O interface 509. In known manner, the mouse 512 may be configured to control movement of a cursor in the video display 508, and to operate various graphical user interface (GUI) controls appearing in the video display 508 with a mouse button. The disk drive or solid state drive 514 may be configured to accept computer readable media 516. The computer device 500 may form part of a network via a network interface 511, allowing the computer device 500 to communicate with other suitably configured data processing systems (not shown).

Although the above principles have been described with reference to certain specific embodiments, various modifications thereof will be apparent to those skilled in the art without departing from the scope of the invention and the claims appended hereto. Other modifications are therefore possible.

### Other Applications

As previously stated, the present invention may be used in applications outside of educational institutions. A skilled reader will understand that the present invention may be used in any application that involves consumption of content that may benefit from application of complexity learning principles.

For example, hospitals typically have educational departments and full time educators who are mandated to ensure staff have continuing education for support safe, high quality care. A major weakness with the educator model is that education is not customized for the learner and is typically given in face-to-face in service workshops. The platform (10) permits an organization to provide educational materials/perspectives in an online format to increase accessibility using the computer implemented method of the present invention. The platform (10) deploys content in a way that a learner has a choice of pathways and significant learning happens learner-to-learner. In the traditional educational model, the teacher or educator decides what needs to be learned and how best to learn it.

For example, general information consumers leverage online forums (Wikipedia etc.) in order to share, exchange and present information about specific topics via the world wide web. The platform (10) may permit a community of internet users, or users of the platform (10) to provide educational materials in an online format on a given topic and in a way that facilitates learning around said topic using the computer implemented method of the present invention. The members of the platform (10) or of the community, which may be gated by an administrator, will enable discourse and discussion, said discourse and discussion optionally adhering to the four elements described above guiding community of inquiry. For example, material such as but not limited to a scientific journal article, may be made available by a user and other users will have the opportunity to comment on the materials and commentary provided by other users, enabled by the content engagement utility or platform (22). Additionally, specific content may organized by a user and/or gathered in a personal space, which may be the ST (14).

In addition, many businesses use internal knowledge databases in order to exchange information about the business's products/services to its employees. The platform (10) may permit the company to leverage emergent learning in identifying issues for product/service improvement, identification of new products/services or as an employee engagement tool. Users, for example employees in a given business unit relevant to a given product/service, may be able to organize and gather specific information in a personal space, which may be the ST (14). In addition, discussion may be permitted amongst the users or amongst a community of users, optionally curated or monitored by a designated expert to ensure accuracy of information, to enable deeper understanding of the product/service by employees, potentially uncovering new applications and other information and/or understanding through discourse and/or discussion.

Further, businesses may use the platform (10) as a customer engagement tool that promotes learning about the corporation's products/services amongst clients, customers or prospective clients and/or customers. For example, and without being limited, customers of the corporation, or other interested parties, may join a community arranged by the business. Said customers may able to organize and gather specific information uploaded by the corporation, or if enabled by the business, in a personal space which may be the ST (14). Such businesses will be able to monitor what information members of the community are engaging with, for example as indicated by content gathered in the ST (14), to determine the level of activity of the community member or platform (10) user. Advertising of new products/services can be presented to users of the platform and/or community (10) depending on their activity on the platform, and the business may reveal new information on the needs of prospective clients and/or customers based on their activity.

### Advantages

Various advantages of the present invention have already been mentioned above. Further advantages of the invention are described below.

The present invention provides a technology that provides tools that allow integration of modern pedagogical approaches to online learning, and provides positive student and teacher online learning experiences.

The present invention provides for the first time an online platform that allows student/teachers to collaborate in participatory learning.

The present invention provides a series of tools for facilitating emergent learning, that can be accessed effectively using a wide variety of network-connected devices including desktop computers, tablet computers, and even smart phones.

The present invention simplifies the process of deploying complexity learning by providing a range of flexible tools for using complexity learning in connection with a wide variety of content libraries.

The present invention provides an engaging and interactive technology platform for connecting with learners. The present invention enables student choice and non-linear connections that increase learning possibilities.

The present invention provides an learning interface where reflection, creative thinking, group problem solving, and critical inquiry provoke learning and deep understanding.

The present invention provides an online learning environment where multiple perspectives can coexist and inform users from multiple disciplines using multiple media forms.

The present invention provides an online learning environment where emotional perspectives are integrated so as to enhance connectivity and shared intelligence.

The present invention provides an online learning environment that informs teachers/leaders of meaningful engagement and learning.

The present invention provides an online learning environment that enables creative and imaginative play with ideas and problem solving.

Another aspect of the present invention is that it takes advantage of the links between complexity and emotions.

The present invention also enables the creation of communities of inquiry to enable an online learning environment facilitating collaborative learning and means of improving learning outcomes between users.

1. A computer system is provided for navigating a plurality of information objects and discovering one or more of the information objects of interest comprising:
(a) at least one computing device linked to a library of information objects, and providing access to a content navigation/discovery utility including:
(i) a global content discovery utility that is made available to a plurality of users to navigate/discover a plurality of information objects using one or more content filters presented in a content navigation/discovery interface; and
(ii) a private or semi-private content discovery utility that is made available to one or more selected users;
wherein the global content discovery utility and the private or semi-private content discovery tool are integrated so as to support user workflows that allow the plurality of users to selectively interact with content through the global content discovery utility and/or the private or semi-private content discovery utility so as to promote emergent and collaborative learning.

2. The computer system of claim 1, wherein the content navigation/discovery utility is configured to allow the plurality of users to navigate and access content in an intuitive way using multiple visual fields.

3. The computer system of claim 1, wherein the computer system comprises a content engagement utility that enables the plurality of users to interact with the plurality of information objects and interact with one another regarding the plurality of information objects, such interactions including one or more of: (a) teacher-student interactions, (b) student-student interactions, (c) group-group interactions, (d) class-class interactions, (e) course-course interactions, (f) discipline-discipline interactions, (g) leader-follower interactions, (h) supervisor-worker interactions, or (i) researcher-team interactions.

4. The computer system of claim 2, wherein the content navigation/discovery utility is configured to allow the plurality of users to share in each other's learning.

5. The computer system of claim 2, wherein the navigation/discovery utility enables the plurality of users to annotate the plurality of information objects.

6. The computer system of claim 5 wherein the navigation/discovery utility enables the plurality of users to annotate at least one of the plurality of information object with one or more perspective.

7. The computer system of claim 6, wherein the one or more content filters enable users to filter and view the plurality of information objects based on one or more of content perspectives, keywords, contributor attributes, courses associated with the plurality of information objects, or date associated with the plurality of information objects.

8. The computer system of claim 1 comprising a utility for encoding the plurality of information objects with emotional responses of the plurality of users to the plurality of information objects based on one or more of understanding, inquiry or changes in thinking.

9. The computer system of claim 1, comprising a journal writing tool that enables the plurality of users to reflect on learning or response to the plurality of information objects.

10. The computer system of claim 9, wherein entries to the journal writing tool are used to automatically encode the plurality of information objects for guiding the plurality of users in navigation/discovery of the plurality of information objects.

11. The computer system of claim 1, wherein the system is configured to enable the one or more selected users to transfer the plurality of information objects between the global content discovery utility and the private or semi-private content discovery utility.

12. The computer system of claim 1, wherein the content navigation/discovery utility is configured to:
(a) display an array of graphical objects representing one or more of the plurality of information objects, the graphical objects including one or more visual attributes that are associated with or indicative of one or more content attributes for the corresponding plurality of information objects, and wherein the visual attributes are linked to the one or more content filters, thereby permitting at least one of the plurality of users to navigate/discover content by selecting, including iteratively, one or more filter options, and thereby triggering changes to the array, wherein the array or changes to the array reveal content related patterns across the plurality of information objects.

13. The computer system of claim 12, wherein the one or more content attributes comprises a user response of at least one of the plurality of users relevant to at least one of the plurality of information objects.

14. The computer system of claim 1, wherein the content/navigation discovery tool is configured for:
(a) recognition of one or more user responses relevant to at least one of the plurality of information objects; and
(b) embedding the one or more user responses into the at least one of the plurality of information objects.

15. The computer system of claim 14, wherein the system receives user responses from:
(a) one or more graphical user interfaces; and
(b) one or more input processors.

16. The computer system of claim 15, wherein the one or more graphical user interfaces comprises a means for the plurality of users to input the one or more user responses.

17. The computer system of claim 16, wherein the one or more input processors comprises a camera.

18. A computer implemented method for engaging in emergent learning comprising:
(a) using one or more processors, initiating one or more content navigation/discovery routines of a navigation/discovery computer networking resource;
(b) one or more users accessing one or more information objects from a library, and the one or more users selectively interacting with the one or more information objects from either (i) a global content discovery utility that is made available to the one or more users to navigate/discover the one or more information objects using one or more content filters presented in a content navigation/discovery interface; or (ii) a private or semi-private content discovery utility that is made available to one or more selected users, so as to enable emergent or collaborative learning;

19. The method of claim 18 comprising the one or more users navigating or accessing the one or more information objects in an intuitive manner using multiple visual fields presented by the navigation/discovery computer networking resource.

20. The method of claim 19, comprising the further step of the one or more users interacting with the one or more information objects or one another regarding the one or more information objects, such interactions including one or more of: (a) teacher-student interactions, (b) student-student interactions, (c) group-group interactions, (d) class-class interactions, (e) course-course interactions, (f) discipline-discipline interactions, (g) leader-follower interactions, (h) supervisor-worker interactions, or (i) researcher-team interactions.

21. The method of claim 20, comprising enabling the one more users, based on such interactions, to share in each other's learning.

22. The method of claim 18, comprising:
(a) the one or more users annotating the one or more information objects with one or more content perspectives, keywords, contributor attributes, courses associated with the one or more information objects, or date associated with the one or more information objects;
(b) filtering the one or more information objects based on one or more of content perspectives, keywords, contributor attributes, courses associated with the one or more information objects, or dates associated with the one or more information objects

23. The method of claim 18, comprising the one or more users encoding the or more information objects with emotional responses of users to the one or more information objects based on one or more of understanding, inquiry or changes in thinking.

24. The method of claim 18, comprising the steps of the one or more users using a journal writing tool to encode the one or more information objects with reflections that enables the one or more users to reflect on learning or response to the one or more information objects.

25. The method of claim 18, comprising the one or more users: (a) viewing a series of icons representing the one or more information objects, and selectively accessing additional information regarding the one or more information objects; (b) selecting one or more perspective for at least one of the one or more information objects, thereby triggering a change in one or more visual attributes of an associated icon; and (c) discovering one or more content relationships between the one or more information objects, using visual patterns between the icons.
